(19) United States
(12) Patent Application Publication
(10) Pub. No.: US 2013/0037359 A1
(43) Pub. Date: Feb. 14, 2013

(54) BRAKE DISC USING TWO DIFFERENT MATERIALS AND METHOD OF PRODUCING THE SAME

(71) Applicants: Yoon Cheol Kim, Seoul (KR); Jae Young Lee, Yongin (KR); Seong Jin Kim, Yongin (KR); Jai Min Han, Ansan (KR); Kyoung Don Yi, Daegu (KR)

(72) Inventors: Yoon Cheol Kim, Seoul (KR); Jae Young Lee, Yongin (KR); Seong Jin Kim, Yongin (KR); Jai Min Han, Ansan (KR); Kyoung Don Yi, Daegu (KR)

(73) Assignees: HYUNDAI MOTOR COMPANY, Seoul (KR); SEOHAN INDUSTRY CO., LTD., Chungcheongbuk-do (KR); KIA MOTORS CORPORATION, Seoul (KR)

(21) Appl. No.: 13/312,542

(22) Filed: Dec. 6, 2011

(30) Foreign Application Priority Data
Aug. 10, 2011 (KR) 10-2011-0079763

(51) Int. Cl. F16D 65/12; B22D 19/00

(52) U.S. Cl. 188/218 XL; 164/103

(57) ABSTRACT

A brake disc is disclosed which includes a friction unit having a coupling aperture formed at a center thereof, insert protrusions and depressions which are provided in a sawtooth formation at predetermined intervals along a circumference of the coupling aperture, wherein chamfers are formed at a predetermined angle on one or more of the upper and lower surfaces of the insert protrusions, and first locking parts locked into upper or lower spaces of the depressions. A hat unit, formed of a material different from that of the friction unit, coupled to the coupling aperture of the friction unit, and including insert recesses formed along a circumference thereof so that the insert protrusions are fitted therein, and second locking parts formed at predetermined intervals in the insert recesses so that they are inserted into the depressions and engage with the first locking parts, and to a method of producing the same.

### CROSS-REFERENCE TO RELATED APPLICATIONS

This application claims under 35 U.S.C. §119(a) priority to Korean Application No. 10-2011-0079763, filed on Aug. 10, 2011, the disclosure of which is incorporated herein by reference in its entirety.

### BACKGROUND OF THE INVENTION

1. Field of the Invention

The present invention relates to a brake disc using different materials, which includes a friction unit and a hat unit which are coupled to each other via cast bonding using different materials, and to a method of producing the same.

2. Description of the Related Art

Because of the shortage of petroleum energy and changes in the weather, worldwide automobile manufacturers are devoting their energy to developing techniques that decrease the rate of fuel consumption. In particular, in order to decrease the rate of fuel consumption, techniques for reducing the weight of automobiles without decreasing the performance thereof are receiving particular attention.

Moreover, a reduction in the weight in the lower portion of the automobile directly affects the performance of automobiles and the rate of fuel consumption thereof. A reduction in the unsprung mass that is directly related to a wheel driving load is efficient at decreasing the rate of fuel consumption, and the related techniques have become drastically advanced.

For example, in order to reduce the weight of a brake disc which is responsible for the main weight of the unsprung mass without decreasing the performance thereof, the disc has been manufactured using a mixture of aluminum and gray cast iron. As shown in FIG. 1, a conventional brake disc 10 includes a hat unit 30 that is to be mounted to a hub and a disk plate 20 that is subjected to friction upon braking, both of which are made of gray cast iron comprising lamellar graphite so that they exhibit superior braking properties, including vibration damping, damping capacity, heat dispersal and a lubricating function. However, because gray cast iron has a specific gravity of about 7.2 g/cm³, the conventional brake disc is heavy, undesirably increasing the rate of fuel consumption.

Thus, there is a need to develop a brake disc using alternative materials such as gray cast iron and aluminum, and a disc structure is also required, in which two different materials are perfectly coupled by a mechanical setup so that performance requirements including heat dispersal or deformation resistance may be met while satisfying durability.

This related art is merely utilized to enhance understanding about the background of the present invention, and will not be regarded as conventional techniques known to those having ordinary knowledge in the art.

### SUMMARY OF THE INVENTION

Accordingly, the present invention has been made keeping in mind the above problems encountered in the related art, and an object of the present invention is to provide a brake disc using different materials, in which a friction unit and a hat unit are coupled via cast bonding to form a coupling portion therebetween thus exhibiting superior durability and performance, and also to provides a method of producing the same.

In order to accomplish the above object, the present invention provides a brake disc using two different materials, comprising a friction unit, including a coupling aperture formed at a center thereof, insert protrusions and depressions which are provided in a sawtooth formation at a predetermined interval along the circumference of the coupling aperture, in which chamfers are formed at a predetermined angle on one or more of an upper surface and a lower surface of the insert protrusions, and first locking parts formed to be locked into upper or lower spaces of the depressions; and a hat unit, which is formed of a material different from that of the friction unit, is coupled to the coupling aperture of the friction unit, and includes insert recesses formed along a circumference thereof so that the insert protrusions are fitted therein, and second locking parts formed at a predetermined interval in the insert recesses so that the second locking parts are inserted into the depressions and thus engage with the first locking parts.

In this aspect, the friction unit and the hat unit may be coupled to each other in a surface contact manner, and the chamfers may be formed at an angle of about 3˜6° on either the upper surface or the lower surface of the insert protrusions of the friction unit.

In this aspect, the chamfers may be formed on both the upper surface and the lower surface of the insert protrusions of the friction unit, provided that a sum of the angles of the chamfers is about 3˜6°. The insert recesses of the hat unit may be provided in ring form, and the second locking parts which engage with the first locking parts may be formed at a predetermined interval in the upper or lower spaces of the insert recesses. In this aspect, the insert protrusions, the depressions and the first locking parts of the friction unit may be processed to a surface roughness of about 6.3˜25 Ra. The lateral surfaces between the insert protrusions of the friction unit and the insert recesses of the hat unit which are coupled to each other may be spaced apart from each other by about 0.3˜1 mm.

Furthermore, the friction unit may be formed of cast iron, and the hat unit may be formed of an aluminum alloy. In this aspect, the friction unit may be composed mainly of Fe and may comprise 3.0˜3.8 wt % of C, 1.0˜2.8 wt % of Si, 1.0 wt % or less of Mn (but excluding 0), 0.2 wt % or less of P (but excluding 0), 0.15 wt % or less of S (but excluding 0) and other inevitable impurities, and the hat unit may be composed mainly of Al and may comprise 0.1 wt % or less of Cu (but excluding 0), 5.5˜8.5 wt % of Si, 0.15˜0.5 wt % of Mg, 0.1 wt % or less of Zn (but excluding 0), 0.3 wt % or less of Fe (but excluding 0), 0.1 wt % or less of Mn (but excluding 0), 0.2 wt % or less of Ti (but excluding 0), 0.15 wt % or less of Sb (but excluding 0) and other inevitable impurities.

Another aspect of the present invention provides a method of producing the brake disc, comprising (a) manufacturing a friction unit using casting and heating the friction unit to obtain a preheated friction unit; (b) inserting the preheated friction unit as an insert into a casting mold; (c) injecting a melt used to make a hat unit into the casting mold and performing casting; and (d) performing solidification, release and post-processing. In this aspect, the method may further comprise pre-processing the friction unit to a surface roughness of 6.3˜25 Ra, and (a) may be performed by heating the friction unit at 300˜400° C. for 1˜3 hours.

In addition, (c) may be performed by heating the melt used to make the hat unit to about to 650˜750 ° C. and then injecting it, and the casting may be performed using gravity casting or melt forging. Also, (d) may be performed by solidifying a cast iron product for about 60˜500 seconds and then releasing it.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view showing a conventional brake disc;

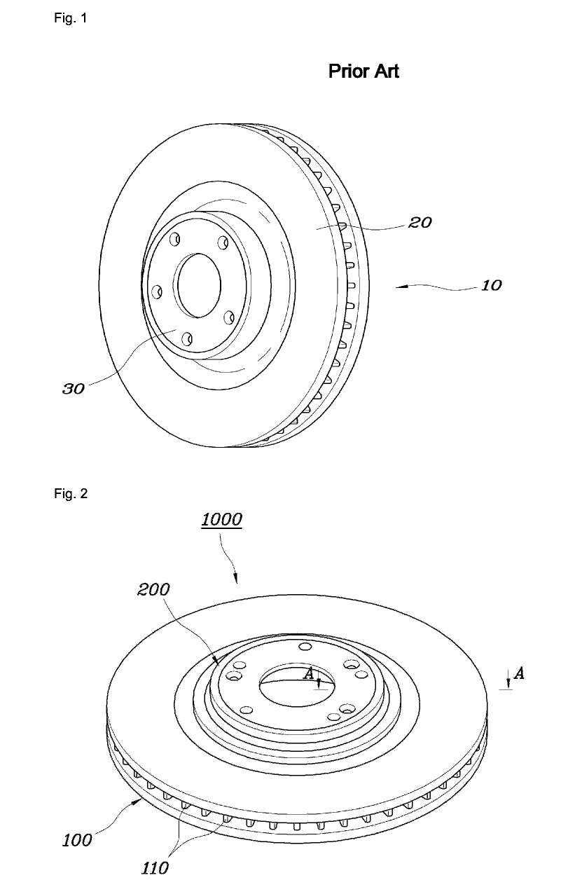

FIG. 2 is a perspective view showing a brake disc using different materials according to an exemplary embodiment of the present invention;

FIGS. 3 and 4 are views showing the friction unit of the brake disc of FIG. 2;

FIGS. 5 and 6 are views showing the hat unit of the brake disc of FIG. 2;

FIGS. 7 and 8 are views showing the coupling portion of the brake disc of FIG. 2; and

FIGS. 9 to 11 are views showing the angle of the chamfers of the brake disc of FIG. 2.

### DESCRIPTION OF SPECIFIC EMBODIMENTS

Hereinafter, a brake disc using different materials and a method of producing the same according to preferred embodiments of the present invention will be described with reference to the accompanying drawings.

It is understood that the tem “vehicle” or “vehicular” or other similar tem as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

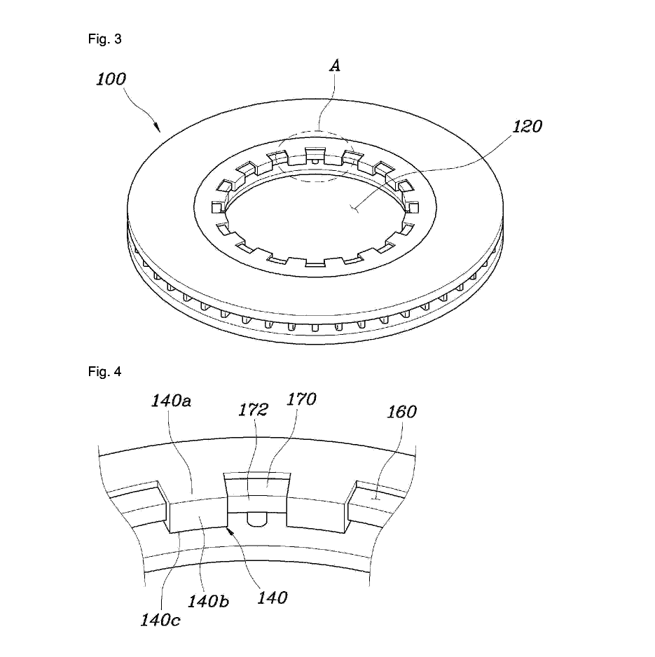

FIG. 2 is a perspective view showing a brake disc 1000 using two different materials according to an exemplary embodiment of the present invention. According to the present invention, the brake disc 1000 includes a friction unit 100 and a hat unit 200 which are made of two different materials and which are configured in such a manner that the friction unit 100 is first cast and then the hat unit 200 is cast using the friction unit as an insert. Furthermore, the friction unit 100 may exhibit the brake performance of the conventional disc brakes which use purely cast iron material. Additionally, the hat unit 200 may reduce the weight of the disc using an aluminum alloy. In this case, it is important that the coupling force of the friction unit 100 and the hat unit 200 be maintained at the conventional level, and thus the present invention pertains to the coupling portion of the friction unit 100 and the hat unit 200.

According to the present invention, the brake disc 1000 includes the friction unit 100 having a coupling aperture 120 formed at a center thereof. Insert protrusions 140 and depressions 160 are provided in a sawtooth formation at predetermined intervals along the circumference of the coupling aperture 120, in which chamfers are formed at a predetermined angle on one or more of the upper surface 140a and the lower surface 140b of the insert protrusions 140. Additionally a plurality of first locking parts 170 are formed to be locked into the upper or lower spaces of the depressions 160. The hat unit 200 is formed of a material different from that of the friction unit 100, and is coupled to the coupling aperture 120 of the friction unit 100. The hat unit 200 also includes insert recesses 240 formed along the circumference thereof so that the insert protrusions 140 are fitted therein, and a second plurality of locking parts 270 that are formed at predetermined intervals in the insert recesses 240 so that the second plurality of locking parts can be inserted into the depressions 160 to engage with the first locking parts 170.

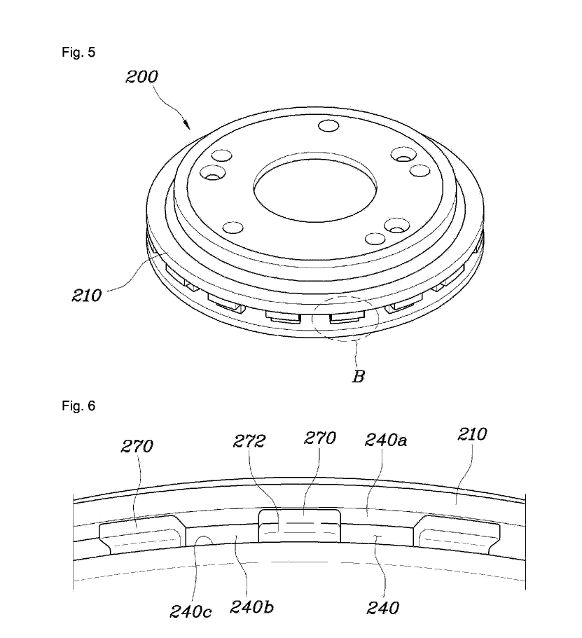

FIGS. 3 and 4 show the friction unit 100 of the brake disc of FIG. 2, and FIG. 4 in an enlarged view of the portion “A” of FIG. 3. The friction unit 100 is configured such that the coupling aperture 120 is formed at the center thereof, and along the circumference of the coupling aperture 120, the insert protrusions 140 and the depressions 160 are provided in a sawtooth formation at predetermined intervals, the chamfers are formed at a predetermined angle on one or more of the upper surface 140a and the lower surface 140b of the insert protrusions 140, and the first locking parts 170 are formed to be locked into the upper or lower spaces of the depressions 160. Furthermore, a plurality of gap supports 110 is formed inside the friction unit, so that heat is dissipated via such gap supports 110.

The friction unit 100 is coupled with the hat unit 200 via the coupling aperture 120 formed at the center thereof. Along the circumference of the coupling aperture 120, the insert protrusions 140 and the depressions 160 are provided in a sawtooth formation. Because the hat unit 200 is coupled to the insert protrusions 140 and the depressions 160 by casting, even when the brake disc is subjected to extreme torque from braking, it may tolerate stress which is intensively applied thereto. Also, because the chamfers are formed at a predetermined angle on one or more locations of the upper surface 140a and the lower surface 140b of the insert protrusions 140, a difference in thermal expansion between cast iron and aluminum upon casting may be absorbed, ultimately preventing stress from being intensively applied due to cracking of the material. Furthermore, the first plurality of locking parts 170 are formed to be locked or interlocked into the upper or lower spaces of the depressions 160, so that the brake disc may safely tolerate the torque generated during braking.

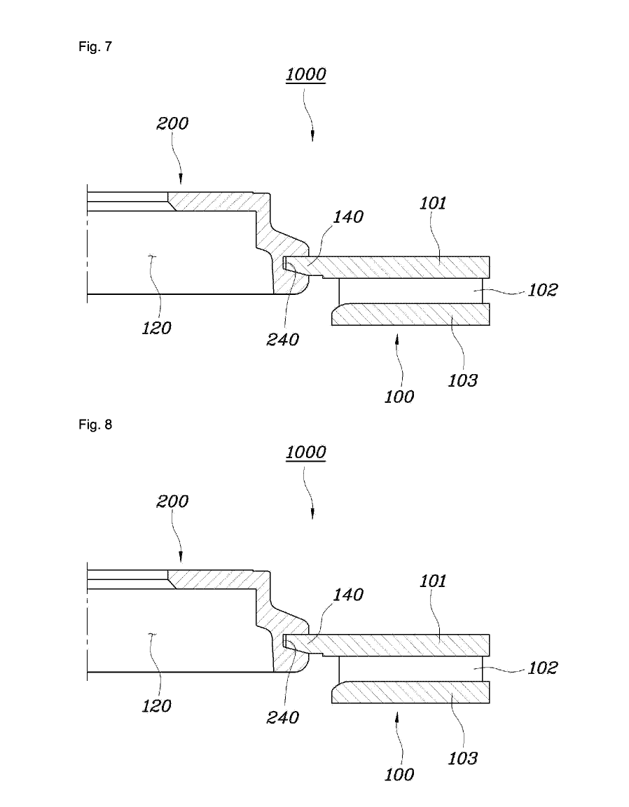

FIGS. 5 and 6 show the hat unit 200 of the disc brake of FIG. 2, and FIG. 6 is an enlarged view of the portion “B” of FIG. 5. The hat unit 200 is formed of a material different from that of the friction unit 100 and is coupled to the coupling aperture 120 of the friction unit 100, and also includes the insert recesses 240 formed along the circumference thereof so that the insert protrusions 140 are fitted therein as well as including the second locking parts 270 formed at predetermined intervals in the insert recesses 240 so that the second plurality of locking parts are inserted into the depressions and thus engage with the first plurality of locking parts 170, respectively. Furthermore, projections 272 may be formed on the lower surface of the second plurality of locking parts 270 so that the ends 172 of the first plurality of locking parts 170 are coupled thereto while coming into contact therewith.

Specifically, the insert recesses 240 are provided in the form of a ring along the circumference 210 of the hat unit 200, and the second 1 plurality of locking parts 270 which engage with the first plurality of locking parts 170 are formed at predetermined intervals in the upper or lower spaces of the insert recesses 240. Thus, the friction unit and the hat unit are coupled by inserting the insert protrusions 140 of the friction unit 100 into the insert recesses 240 and engaging the first plurality of locking parts 170 with the second plurality of locking parts 270, whereby the brake disc may tolerate the torque generated during braking. Also, the friction unit 100 and the hat unit 200 are coupled to each other in a surface contact manner, thus ensuring that the locking and friction operations therebetween generate the braking force.

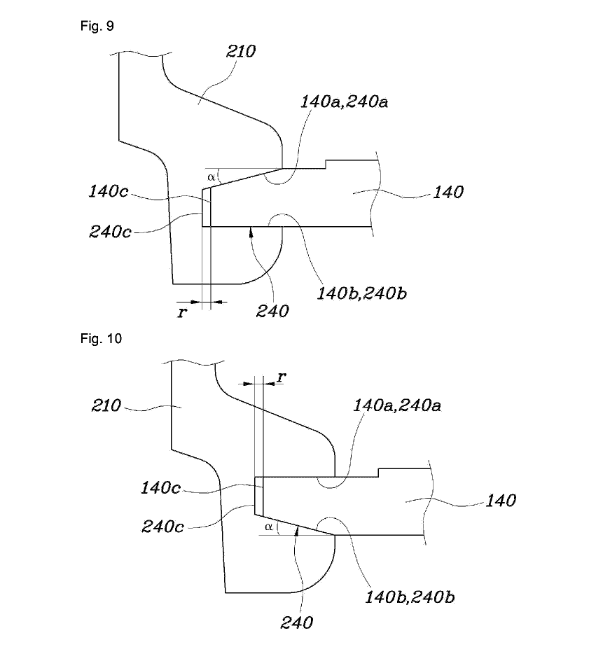

FIGS. 7 and 8 show the coupling portion of the brake disc of FIG. 2, in which the friction unit 100 includes an upper unit 101, a lower unit 103 and a rib 102 used to connect the upper unit 101 and the lower unit 102. As such, the upper unit 101 may be coupled to the hat unit 200, or the lower unit 103 may be coupled to the hat unit 200.

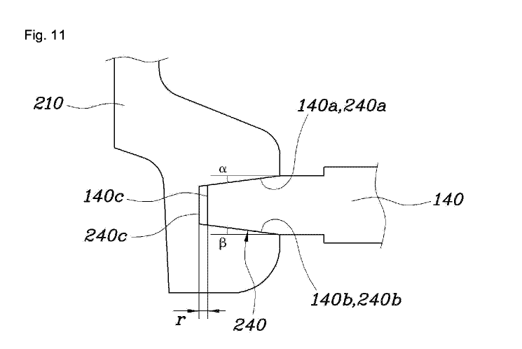

FIGS. 9 to 11 show the angle of chamfers of the brake disc of FIG. 2. On either the upper surface 140a or the lower surface 140b of the insert protrusions 140 of the friction unit 100, the chamfers may be formed at an angle of about 3˜6°. Alternatively, the chamfers may be formed on both the upper surface 140a and the lower surface 140b, provided that the sum of the angles of the chamfers falls in the range of about 3˜6°.

Cast iron and aluminum have largely different coefficients of thermal expansion. Thus, when they are coupled to each other using casting, the contraction of the hat unit 200 made of aluminum is greater. Hence, the case where the insert protrusions 140 of the friction unit 100 are provided in rectangular form does not cope in an appropriate manner with the contraction of the hat unit 200, and thus an intense amount of stress is applied therein because of the torque generated during braking, undesirably increasing the probability of the disc breaking. Accordingly, the chamfers are formed on the insert protrusions 140 of the friction unit 100, whereby the hat unit 200 is naturally coupled to wrap the insert protrusions 140 while it contracts as it solidifies after being cast. Thereby, defects are minimized when coupling the friction unit 100 and the hat unit 200 to each other.

The upper surface 140a and the lower surface 140b of the insert protrusions 140 come into close contact with the upper surface 240a and the lower surface 240b of the insert recesses 240 by means of such chamfers, and the lateral surfaces 140c, 240c of both are opposite to each other and are spaced apart from each other by a predetermined distance. Being spacing apart allows differences in expansion due to heat generated upon braking to be absorbed, and may prevent the heat from being transferred from the friction unit 100 to the hat unit 200 to some degree.

The chamfers may be formed at an angle α of about 3˜6° on either the upper surface 140a or the lower surface 140b of the insert protrusions 140 of the friction unit 100, or the chamfers may be formed on both the upper surface 140a and the lower surface 140b, provided that the sum of the angles of the chamfers falls in the range of about 3˜6°.

Angles of the chamfers in the range of about 3˜6° are calculated from the difference in the coefficient of thermal expansion of the two materials, as shown in Table 1 below.

TABLE 1

| | Coeffi. Of Thermal | Temp. | Thick. of | Radius of | Thick. | Radius | Chamfer | |
|---|---|---|---|---|---|---|---|---|
| Material | Expansion | Change | Coupling Portion | Coupling Portion | Decrement | Decrement | Angle | |
| Al Alloy | 2.15E−05 | 630 | 8 | 95 | 0.11 | 1.29 | | |
| Cast Iron | 1.05E−05 | 320 | 8 | 95 | 0.03 | 0.32 | α | 4.8 |
| | | | | | 0.08 | 0.97 | | |

As is apparent from the above table, when the melt temperature of the aluminum alloy is 650° C. and the temperature of the preheated cast iron is 340° C., during the cooling to room temperature at namely 20° C., the thickness of the coupling portion is reduced due to the respective coefficients of thermal expansion. In the case of aluminum which has a high coefficient of thermal expansion, the decrement is much larger and the difference in decrement between aluminum and cast iron is about 0.08 in terms of thickness and about 0.97 in terms of radius. Thus, when the angle between the thickness and the radius is determined using ARC TANGENT, the chamfer angle α of about 4.8° is evaluated to be proper. This angle may vary depending on changes in temperature. Taking into considering the appropriate temperature range, the angle of the chamfers may fall in the range of about 3˜6°.

On the other hand, the insert protrusions 140, the depressions 160 and the first locking parts 170 of the friction unit 100 are processed to a surface roughness of about 6.3˜25 Ra. Herein, Ra of the roughness indicates an arithmetic mean defined by ISO 4287:1997. Because an appropriate frictional force is exhibited when these parts are in the corresponding roughness range, the friction unit and the hat unit may cause an appropriate slip while exhibiting a frictional force that is the result of casting. If the roughness is too high, slipping does not occur, and stress is intensively applied instead. In contrast, if the roughness is low (i.e. below 6.3 Ra), even when the chamfers are formed, the coupling force therebetween may be weakened.

Also, the lateral surfaces 140c, 240c between the insert protrusions 140 of the friction unit 100 and the insert recesses 240 of the hat unit 200 which are coupled to each other are spaced apart from each other by 0.3˜1 mm. The spacing distance is represented by “γ” in FIGS. 9 to 11. When such a spacing distance is formed, the slip distance is ensured upon thermal expansion, and heat transfer is prevented, thus enabling braking performance to be maintained for a long period of time.

The friction unit 100 is composed mainly of Fe and comprises 3.0˜3.8 wt % of C, 1.0˜2.8 wt % of Si, 1.0 wt % or less of Mn (but excluding 0), 0.2 wt % or less of P (but excluding 0), 0.15 wt % or less of S (but excluding 0) and other inevitable impurities. The hat unit 200 is composed mainly of Al and comprises 0.1 wt % or less of Cu (but excluding 0), 5.5˜8.5 wt % of Si, 0.15˜0.5 wt % of Mg, 0.1 wt % or less of Zn (but excluding 0), 0.3 wt % or less of Fe (but excluding 0), 0.1 wt % or less of Mn (but excluding 0), 0.2 wt % or less of Ti (but excluding 0), 0.15 wt % or less of Sb (but excluding 0) and other inevitable impurities.

In addition, a method of producing the brake disc according to the present invention comprises (a) manufacturing a friction unit 100 using casting and heating it to obtain a preheated friction unit, (b) inserting the preheated friction unit 100 as an insert into a casting mold, (c) injecting a melt used to make a hat unit 200 into the casting mold and casting it, and (d) performing solidification, release and post-processing. Also the method may further include pre-processing the friction unit 100 to have a surface roughness of about 6.3˜25 Ra.

The friction unit is first cast using cast iron and then pre-processed to the above roughness. Subsequently, the friction unit 100 is heated at about 300˜400° C. for 1˜3 hours so that stress is relieved via annealing. In this state, the friction unit material is bound to the aluminum alloy and cast to attain high coupling force.

In (c), the aluminum alloy melt which is used to make the hat unit 200 is heated to about 650˜750° C. and then injected, and casting may be performed using gravity casting or melt forging. Although there are a variety of casting processes, gravity casting or melt forging is particularly useful in terms of the durability of the coupling portion being greatly increased. Finally, in (d), the cast iron product is solidified for about 60˜500 seconds and then released.

The brake disc thus produced was tested. As results, maximum stress was measured to be 39 MPa, and yield strength was also measured to be 210 MPa. Thus, the durability of the brake disc according to the present invention is evaluated to be equal or superior to that of the conventional brake disc made of cast iron material.

As described hereinbefore, the present invention provides a brake disc using two different materials and a method of producing the same. According to the present invention, because the hat unit is made of an aluminum alloy having low specific gravity, it is possible to reduce the weight of the brake disc. Also, although lightweight, the brake disc according to the present invention has durability at the conventional level.

Although the preferred embodiments of the present invention have been disclosed for to illustrative purposes, those skilled in the art will appreciate that various modifications, additions and substitutions are possible, without departing from the scope and spirit of the invention as disclosed in the accompanying claims.

What is claimed is:

1. A brake disc using two different materials, comprising:
a friction unit, including:
a coupling aperture formed at a center thereof,
insert protrusions and depressions which are provided in a sawtooth formation at a predetermined interval along a circumference of the coupling aperture, in which chamfers are formed at a predetermined angle on one or more of an upper surface and a lower surface of the insert protrusions, and
a first plurality of locking parts formed to be locked into upper or lower spaces of the depressions; and
a hat unit, which is formed of a material different from that of the friction unit, is coupled to the coupling aperture of the friction unit, and includes:
insert recesses formed along a circumference thereof so that the insert protrusions are fitted therein, and
a second plurality of locking parts formed at a predetermined interval in the insert recesses so that the second plurality of locking parts are inserted into the depressions and thus engage with the first plurality of locking parts.

2. The brake disc of claim 1, wherein the friction unit and the hat unit are coupled to each other in a surface contact manner.

3. The brake disc of claim 1, wherein the chamfers are formed at an angle of 3˜6° on either the upper surface or the lower surface of the insert protrusions of the friction unit.

4. The brake disc of claim 1, wherein the chamfers are formed on both the upper surface and the lower surface of the insert protrusions of the friction unit, provided that a sum of angles of the chamfers is 3˜6°.

5. The brake disc of claim 1, wherein the insert recesses of the hat unit are provided in ring form, and the second locking parts which engage with the first plurality of locking parts are formed at a predetermined interval in upper or lower spaces of the insert recesses.

6. The brake disc of claim 1, wherein the insert protrusions, the depressions and the first plurality of locking parts of the friction unit are processed to a surface roughness of 6.3˜25 Ra.

7. The brake disc of claim 1, wherein lateral surfaces between the insert protrusions of the friction unit and the insert recesses of the hat unit which are coupled to each other are spaced apart from each other by 0.3˜1 mm.

8. The brake disc of claim 1, wherein the friction unit is formed of cast iron, and the hat unit is formed of an aluminum alloy.

9. The brake disc of claim 1, wherein the friction unit is composed mainly of Fe and comprises 3.0˜3.8 wt % of C, 1.0˜2.8 wt % of Si, 1.0 wt % or less of Mn (but excluding 0), 0.2 wt % or less of P (but excluding 0), 0.15 wt % or less of S (but excluding 0) and other inevitable impurities, and the hat unit is composed mainly of Al and comprises 0.1 wt % or less of Cu (but excluding 0), 5.5˜8.5 wt % of Si, 0.15˜0.5 wt % of Mg, 0.1 wt % or less of Zn (but excluding 0), 0.3 wt % or less of Fe (but excluding 0), 0.1 wt % or less of Mn (but excluding 0), 0.2 wt % or less of Ti (but excluding 0), 0.15 wt % or less of Sb (but excluding 0) and other inevitable impurities.

10. A method of producing the brake disc of claim 1, comprising:
(a) manufacturing a friction unit using casting and heating the friction unit to obtain a preheated friction unit;
(b) inserting the preheated friction unit as an insert into a casting mold;
(c) injecting a melted material used to make a hat unit into the casting mold and performing casting; and
(d) performing solidification, release and post-processing.

11. The method of claim 10, further comprising pre-processing the friction unit to a surface roughness of 6.3˜25 Ra.

12. The method of claim 10, wherein (a) is performed by heating the friction unit at 300˜400° for 1˜3 hours.

13. The method of claim 10, wherein (c) is performed by heating the melt used to make the hat unit to 650˜750° C. and then injecting it.

14. The method of claim 10, wherein in (c) the casting is performed using gravity casting or melt forging.

15. The method of claim 10, wherein (d) is performed by solidifying a cast iron product for 60˜500 seconds and then releasing it.
